(19) United States
(12) Patent Application Publication
(10) Pub. No.: US 2008/0223713 A1
(43) Pub. Date: Sep. 18, 2008

(54) Photocatalyst Having Improved Quantum Efficiency and Method for Use in Photocatalytic and Photosynthetic

(76) Inventors: Huifang Xu, Madison, WI (US); Rakesh Reddy Yeredla, Naperville, IL (US); Kuang-sheng Hong, Madison, WI (US)

Correspondence Address: WISCONSIN ALUMNI RESEARCH FOUNDATION, C/O BOYLE FREDRICKSON S.C, 840 North Plankinton Avenue, Milwaukee, WI, 53203, US

(21) Appl. No.: 12/048,286

(22) Filed: Mar. 14, 2008

Related U.S. Application Data
(60) Provisional application No. 60/906,995, filed on Mar. 14, 2007.

(51) Int. Cl. B01J 19/12; B01J 21/06

(52) U.S. Cl. 204/157.15; 502/300; 502/232; 502/350; 423/610

(57) ABSTRACT

The present invention involves increasing the quantum efficiency in titania photocatalysts for photocatalytic (oxidation of acetaldehyde) and photosynthetic (photosplitting of water) reactions by integrating the titania photocatalyst with a polar mineral having surface electrical fields due to pyroelectric and piezoelectric effects, and by adjusting the nanostructure of the photocatalyst materials. The photocatalytic reactivity of titania powder is increased due to the effect of electric field present on the surface of polar mineral material on the photocatalytic effect of commercial titania with respect to photolysis of water. Additionally, the photocatalytic performance of pure phase rutile and anatase nanostructures with well defined morphologies was found to improved with respect to certain photocatalytic reactions in comparison with non-structured titania.

### CROSS-REFERENCE TO RELATED APPLICATIONS

This application claims priority from U.S. Provisional Patent Application Ser. No. 60/906,995, filed on Mar. 14, 2007, the entirety of which is expressly incorporated by reference herein.

### FIELD OF THE INVENTION

The present invention relates to photocatalysts, and more particularly to photocatalysts capable of use in heterogeneous photocatalysis to activate the photocatalyst using light energy to drive redox reactions.

### BACKGROUND OF THE INVENTION

Hydrogen is widely considered to be one of the fuels of the future. It is non-polluting, renewable, and very flexible in conversion to other forms of energy. Hydrogen is viewed as a very attractive alternative to fossils fuels as a source of energy because the deposits of fossil fuels are limited and fossils fuels are widely believed to be responsible for the global warming and long-term climate change. Hydrogen is an environmentally friendly fuel the combustion of which results in the generation of water, which is neither an air pollutant nor a green house gas.

As of today, hydrogen is produced primarily through steam reforming of methane. This technique, however, results in the emission of carbon dioxide (CO₂), which is a greenhouse gas. Hydrogen produced through water electrolysis also cannot be considered environmentally friendly as the electricity used is obtained from combustion of fossil fuels. The growing interest in hydrogen has resulted in the increasing need to develop hydrogen production technologies based on the utilization of renewable sources of energy, particularly solar energy.

There is also a need or an improved method or manner to deal with the growing environmental and health problems created by hazardous volatile organic compounds (VOCs) that are generated in a multitude of industrial and commercial processes.

While many different potential solutions have been developed for attempting to address these problems, the prior art attempts have fallen short of being able to completely remove these problems. For potentially addressing both of these issues, one option that has undergone significant development is the process of photocatalysis.

In particular, heterogeneous photocatalysis is a process in which light energy is used to activate a catalyst to drive a reaction. Photocatalysts are generally semiconductors which have a fully occupied valence band (VB) and an empty conduction band (CB) in their electronic structure. The valence band and the conduction band are separated by an energy gap (E_{g}). Upon absorption of light having energy equal to or greater than the band gap, the valence electrons can become excited, causing them to overcome the energy gap and jump from the valence band into the conduction band. The resulting electron deficiencies in the valence band are called ‘holes’ and the electron-hole pairs are referred to as the charge carriers. FIG. 1 schematically illustrates the electronic band structure of a semiconductor in ground state and that of a photoexcited semiconductor.

The photo-generated charge carriers are energy rich and this energy can be used electrically (solar cells), or chemically (photocatalytic redox reactions), or to change the catalyst surface itself (superhydrophilicity). When a semiconductor absorbs light to produce electron-hole pairs, the following processes occur:
(i) the electron-hole pairs are separated within the semiconductor particle and diffuse to the surface where they can take part in redox reactions or convert to other forms of energy;
(ii) the electron-hole pairs can recombine in the semiconductor resulting in the loss of energy in the form of a radiative or non-radiative transition, which is highly undesirable for catalysis.

In general, photocatalyzed reactions can be represented by the general reaction:

(O_{X1})_{ads}+(Red₂)_{ads}→(TiO₂+hν)→(Red₁)+(O_{X2})

where the subscript ads represents the adsorbed species on the surface of the photocatalyst. If the sign of the change in Gibbs free energy (ΔGₒ) of this reaction is negative, it is defined as a photocatalytic reaction (spontaneous or “downhill”). If ΔGₒ is positive for the reaction, it is defined as a photosynthetic reaction where there is a net increase in the free energy of the system (“uphill”). Photo-oxidation of organic compounds like acetate, acetaldehyde etc on TiO₂ surfaces are examples of photocatalytic reactions while production of H₂ from H₂O, CH₃OH from CO₂, NH₃ from N₂ are examples of photosynthetic reactions which are not spontaneous and need an extra input of energy.

### 1. Hydrogen Production Via Water Splitting

With regards to the mechanism of the reaction, the principle of photo-catalytic water decomposition makes use of a single semiconductor electrode unlike the two electrodes in photo-electrochemical decomposition. In photo-catalytic water decomposition, both the oxidation and the reduction processes take place on the surface of the semiconductor photocatalyst, which acts as both the anode and the cathode. Also, a mixture of hydrogen and oxygen evolves from the same location on the surface of the semiconductor material in contact with an electrolyte (water).

For photodecomposition of water to occur on a semiconductor material, thermodynamic considerations require that:
Conduction Band minimum (E_{CB}) should be higher (more negative on electrochemical scale) than H₂/H₂O level (reduction of H₂O to H₂).
Valence Band maximum (E_{VB}) should be lower (more positive on electrochemical scale) than H₂O/O₂ level (Oxidation of H₂O to O₂).
   FIG. 2 schematically represents the positions of the conduction band and the valence band compared to the water redox potentials on the electrochemical scale vs. Standard Hydrogen Electrode (SHE) and on an Eh-pH diagram at pH=0. The difference ΔE₁ between the CB minimum and the H₂/H₂O redox potential is called the driving potential for the reduction reaction and the corresponding difference ΔE₂ between the VB maximum and the H₂O/O₂ redox potential is called the driving potential for the oxidation reaction.

The mechanism for the photogeneration of hydrogen can be illustrated by considering the energetics of an n-type semiconductor/electrolyte junction. FIG. 3 shows a schematic energy diagram of the system prior to immersing the semiconductor in the electrolyte. The vertical axis represents the potential, with the top of the axis at the vacuum level and the horizontal axis represents the different components spatially. The relationship between the potential on the vacuum scale and the potential on the redox scale (SHE) is given by:

E_{vac}=E°_{SHE}+4.5 eV

For this n-type semiconductor, before contact with the electrolyte, the free electrons in the semiconductor are at a higher potential E_{F} than those in the electrolyte E_{F,redox}. When the semiconductor is brought into contact with the electrolyte, electrons of higher energy from the semiconductor are transferred into the electrolyte until the Fermi levels of the semiconductor and the electrolyte, E_{F} and E_{F,redox} equalize. This leads to the development of a positively charged region near the surface of the semiconductor, depleted of electrons, known as the depletion layer and is similar to the layer formed at a semiconductor/metal junction known as a Schottky barrier. As a consequence, the conduction and valence bands are bent near the surface of the semiconductor to establish a potential barrier preventing further transfer of electrons to the electrolyte. The depletion layer is also called the space charge (SC) layer, best shown in FIG. 4. An electric field exists in the space charge layer at the surface of the semiconductor to a depth of 5 to 200 nm. For an n-type semiconductor, the direction of the field is from the bulk of the semiconductor towards the interface. Thus, if an electron-hole pair forms in the space charge region, the electron moves towards the bulk of the semiconductor, and the hole moves towards the surface.

Thus, the electric field that forms spontaneously at the interface accomplishes electron-hole separation. A thin (a few angstroms) layer of charged ions also forms, adsorbed to the electrolyte side of the interface known as the Helmholtz layer. The ions have the opposite sign to the charge induced in the depletion layer of the solid. The corresponding change in potential across the layer, V_{H}, effectively increases the magnitude of the band bending in the semiconductor. The band bending is thus given by:

V_{B}=E_{F}−E_{flat band}

where E_{flat band} is the chemical potential of the electrons in the semiconductor in contact with an electrolyte at which the conduction and the valence bands are flat. When the semiconductor material is irradiated, electron-hole pairs are generated inside the semiconductor which generates a photovoltage, Vₚₕₒₜₒ. When the charge carriers diffuse to the space charge region, due to the electric field present in the space charge region, they are separated and the electrons migrate into the bulk of the semiconductor whereas the holes migrate onto the surface of the semiconductor. This fills the depleted layer with extra positive charge which serves to shield the negative charge which was transferred to the electrolyte in the dark equilibrium situation. The band bending at the interface is reduced and E_{F} is moved towards the flat band potential. As a result the change in potential between the surface and the bulk is reduced, until the rate of charge carrier generation by light is balanced by the rate of recombination. This is shown in FIG. 5 where the semiconductor/electrolyte junction is illuminated.

For photosplitting of water, the redox species in the electrolyte (water) are the H₊/H₂ and the O₂/H₂O systems. For electron transfer to occur from the semiconductor to the redox species, the chemical potential (E_{F}) of the electrons in the semiconductor should be greater (higher) than the chemical potential of the electrons in the redox species (E_{F,redox}).

If this condition is satisfied, electrons can migrate from the bulk of the semiconductor onto the surface where they can reduce the H₊ ions to hydrogen gas. Similarly holes can migrate onto the surface where they can oxidize the H₂O molecule into oxygen gas. Frequently, a sacrificial reducing agent like acetate or ascorbic acid is used as a donor of electrons to the semiconductor and the organic molecule itself is oxidized by the photo-generated holes.

For the reasons stated previously, the properties of interest for a semiconductor material used for water decomposition are its bandgap, flat band potential, Schottky barrier, electrical resistance, Helmholtz potential, microstructure and corrosion resistance. The performance characteristics of the semiconductor material should also include high efficiency, durability, low cost of manufacturing, low cost and ease of maintenance. In other words, for effective use in splitting water for the formation of hydrogen, a good photocatalyst material must have:
a) an energy band gap which is optimum for water splitting (approximately 2 eV with conduction and valence band edges optimally placed with respect to the water redox potentials);
b) strong optical absorption in the visible and ultraviolet spectral regions;
c) good stability in strong electrolytes; and
d) efficient charge transfer properties between the semiconductor and the electrolyte.

There are numerous materials with small bandgaps such as CdS, CdSe, PbS, MoS₂ and Cu₂O which absorb light in the visible region. Unfortunately these materials exhibit photoanodic corrosion in the electrolyte and are also toxic.

Many other different types of materials have been identified as being suitable for photosplitting of water and the effect of the material structure on their performance, for example, using titania nanotubes, nickel doped indium-tantalum oxide, chemically modified titania, and mixed oxide semiconductor photocatalysts. Additionally, materials with relatively wide band gaps such as TiO₂, ZnO, SrTiO₃ and ZnS have good photostability but limited light absorption and hence low efficiencies.

Due to oxygen vacancies, TiO₂ is an n-type semiconductor. These vacancies are formed according to the reaction:

Oₒⁿ→(TiO₂)→Vₒⁿⁿ+2e−+1/2O₂

where the Kroger-Vink defect notation is used to explain that inside TiO₂, a positively (+2) charged oxide ion vacancy (Vₒ) is formed upon the release of two electrons and molecular oxygen.

Titanium dioxide is a preferred semiconductor material to be used for this purpose that is processed primarily from ilmenite or rutile beach sand. These ores are the principal raw materials used in the manufacture of commercial-grade TiO₂. TiO₂ is widely used in paints, foods, and paper manufacturing as a white pigment due to its exceptionally high index of refraction. It is also used in health and beauty products as a protectant against ultraviolet (UV) light. However, TiO₂ is also one of the most widely used photocatalysts because it is non-toxic, inexpensive and is stable to photo-corrosion over a wide range of pH and solutions.

The three important polymorphs of titania are brookite (orthorhombic), rutile (tetragonal) and anatase (tetragonal). In bulk phase, rutile is the thermodynamically most stable form. The structures of these three polymorphs can be discussed in terms of (TiO₂₆₋) octahedrals. The three crystal structures differ by the distortion of each octahedral and by the assembly patterns of the octahedral chains. Anatase can be regarded to be built up from octahedrals that are connected by their vertices, and in rutile and brookite, both the edges and the corners are connected. The brookite structure is not used often for experimental investigations. The crystal structures of rutile and anatase forms of titania are shown in FIG. 6.

Anatase having a band gap of 3.2 eV is the most photo-active crystal phase of TiO₂. Rutile TiO₂ having a band gap of 3.0 eV and a more compact crystal is less photo-active than rutile. It has been suggested that this increased photoreactivity is due to anatase's slightly higher Fermi level, lower capacity to adsorb oxygen and higher degree of hydroxylation (i.e., number of hydroxy groups on the surface). Reactions in which both crystalline phases have the same photoreactivity or rutile a higher one are also reported. The disagreement of the results may lie in the intervening effect of various coexisting factors, such as specific surface area, pore size distribution, crystal size, crystal shape and preparation methods, or in the way the activity is expressed. Also the effective mass of an electron in rutile (20 mₑ) is twenty times more than that of an electron in anatase (˜mₑ). Due to this, the mobility of an electron in the conduction band of anatase is greater than that of an electron in the conduction band of rutile, and so can diffuse to the surface and take part in the photochemical reactions much more effectively than in rutile.

### 2. Oxidation of VOCs

In addition to the use of TiO₂ in photosplitting of water, heterogeneous photocatalysis using TiO₂ has been extensively investigated as a method to oxidize organic pollutants in water and air, including phenols, chlorinated hydrocarbons and other hydrocarbons.

There have been various reports on the complete mineralization (photocatalytic oxidation) of organic compounds to CO₂ and H₂O by heterogeneous photocatalysis. The application of semiconductor photocatalysis for the remediation has been used successfully for a wide variety of compounds such as alkanes, aliphatic alcohols, aliphatic and aromatic carboxylic acids, aldehydes, alkenes, phenols and some other simple aromatic compounds. A variety of metal oxide semiconductors have been tested as photocatalysts which include TiO₂ (E_{g}=3.2 eV), WO₃ (E_{g}=2.8 eV), SrTiO₃ (E_{g}=3.2 eV) and ZnO (E_{g}=3.2 eV). However, TiO₂ has proven to be the most suitable for widespread environmental applications, because it is biologically and chemically inert, resistant to photocorrosion and chemical corrosion and inexpensive. The conduction and valence bands of anatase TiO₂ occur at −0.1 and +3.0 V respectively vs. SHE; i.e the holes generated by light excitation are very powerful oxidants.

The basic processes occurring in semiconductor photocatalysis for mineralization of organic compounds is shown in FIG. 7 where A denotes an acceptor and D denotes a donor of electrons.

A typical example is the oxidation of acetic acid according to the reaction:

CH₃COOH+2O₂→(TiO₂+hν)→2CO₂+2H₂O

A variety of intermediates have been observed in the reaction such as HCO₂₋, CHOCO₂₋, HCHO, CH₃OOH, CH₃COOOH and H₂O₂. This is a downhill reaction which is catalyzed by TiO₂ in presence of light. The holes produced by the photo-excitation are used for the oxidation of acetic acid whereas the electrons are transferred to O₂. Both the reactions, reduction of the electron acceptor and oxidation of the pollutant molecule occur simultaneously on the surface of the photocatalyst. The slowest process determines the overall reaction rate. The radical ions formed after the interfacial charge transfer reactions can participate in several pathways in the degradation process:
They may react chemically with themselves or with surface-adsorbed compounds.
They may recombine by back electron transfer reactions, especially when they are trapped near the surface.
They may diffuse from the semiconductor surface and participate in chemical reactions in the bulk solution.
   However, the detailed mechanism of photocatalytic process on TiO₂ surface is still not completely understood. Nevertheless, two critical processes determine the overall quantum efficiency of interfacial charge transfer:
the competition between charge-carrier recombination and trapping (picoseconds to nanoseconds).
the competition between trapped carrier recombination and interfacial charge transfer (microseconds to milliseconds).
   An increase in either charge-carrier lifetime or the interfacial electron-transfer rate is expected to lead to higher quantum efficiency for steady state photo-catalysis. A point of contention in the oxidation mechanism is whether the valence band holes can react directly with organic compounds before they are trapped, or whether oxidation occurs indirectly via surface bound hydroxyl radicals (i.e., a trapped hole at the surface).

However, even with the ability of titanium dioxide to adequately function as a photocatalyst for the processes of both water splitting and VOC oxidation, there are some significant shortcomings concerning the performance of TiO₂ in each process. More particularly, the two challenging issues in the use of titania photocatalysis for photosplitting water to produce hydrogen and for oxidizing volatile organic compounds are (i) the relatively low quantum efficiencies of the catalysts and (ii) the requirement of near UV light for photo-activation.

First, the quantum efficiency, i.e., the efficiency with which light is utilized to drive redox reactions, is inherently low in TiO₂ because the processes of electron-hole generation and the recombination are much faster than the rates at which the electrons and holes are trapped and participate in redox reactions on the surface of the TiO₂ particles. In addition, upon absorption of light of relatively high intensity, the number of photo-generated charge carriers is much greater than the number of electron or hole traps or surface defects in the TiO₂ particles or the number of adsorbed molecules. Therefore, as the light intensity increases, the fraction of the photogenerated charge carriers taking part in the redox reactions decreases.

The second challenging issue in titania photocatalysis is the requirement of UV light for the activation of the photocatalyst. FIG. 8 shows the solar emission spectrum measured at the sea level. It can be seen from the diagram that currently, only a small fraction (less than 2.5%) of the solar radiation can be used to activate titania.

There have been numerous attempts to modify the band gap of titania to absorb the visible light present abundantly in the solar radiation. Recently, significant progress has been made in lowering the photo-threshold energy for TiO₂ photoexcitation through doping with impurity atoms including N, C, S or transition metals. However, the effect of transition metal doping of titania has been somewhat controversial in literature. While certain nitrogen doped TiO₂ films (TiO₂₋ₓNₓ) have been demonstrated to show enhanced photocatalytic activity in the visible region through photodecomposition of organic compounds methylene blue and acetaldehyde, the addition of dopants to TiO₂ alters the surface characteristics, creating defects at the surface of TiO₂ particles. Such sites can affect both electron-hole recombination dynamics and absorption characteristics of the TiO₂ particles, greatly reducing the quantum efficiency and, therefore, the usefulness of the photocatalyst, regardless of the benefits realized in lower the photo-activation threshold for the photocatalyst.

Therefore, it is desirable to develop a photocatalyst material that can be used in performing various redox reactions, e.g., water splitting and VOC oxidation processes, but that also significantly improves the quantum efficiency of the photocatalyst. The photocatalyst should be formed in a manner that allows it to be used in these processes in the same manner as prior art photocatalysts, without any special considerations or requirements.

### SUMMARY OF THE INVENTION

According to one aspect of the present invention, a photocatalyst is provided that is formed as a combination of a conventional photo-active semiconductor material and a mineral, such as a silicate material, which is not a perovskite-based ferroelectric material. The silicate material has an inherent electrical polarity that functions on the semiconductor material to enhance the separation of the electron hole pairs generated in the semiconductor, and thus increases the quantum efficiency of the semiconductor, when light is directed at the semiconductor. The silicate crystals of tourmaline and quartz are chemically stable and physically durable in both air and aqueous solution.

The efficiency of a heterogeneous photocatalytic process can be increased by (i) increasing the range and intensity absorbed by the photocatalyst i.e. the photon efficiency and (ii) increasing the separation of the photogenerated electron-hole pairs in the photocatalyst i.e. the quantum efficiency. In the scope of the present invention, the results show an increase in the quantum efficiency in titania photocatalysts for photocatalytic (oxidation of acetaldehyde) and photosynthetic (photosplitting of water) reactions. This increase in the quantum efficiency is accomplished in one manner by integrating the titania photocatalyst with a polar mineral, like tourmaline or quartz, having surface electrical fields due to pyroelectric effect (tourmaline) and piezoelectric effect (quartz). These surface electric fields can increase the photogenerated electron-hole separation in a semiconductor photo catalyst.

When titania integrated with a polar mineral is used as the photocatalyst in photosplitting of water, there is a marked increase in performance compared to using the titania photocatalyst alone. To illustrate this, photosplitting of water is conducted with these photocatalysts in solutions of various pHs. The amount of hydrogen produced from photosplitting of water increased considerably with a polar mineral-integrated titania photocatalyst compared to pure titania alone. In particular, the maximum amount of hydrogen evolved with polar mineral-integrated titania in a system using pure water as the solution is about 3 times the amount evolved when using titania alone. This enhancement in the production of hydrogen is also evident systems containing solutions of different pH values. The enhancement in the performance can be attributed to a reduction in the Schottky barrier for electrons to migrate to the surface of the semiconductor. The electric field developed in the space charge layer of a semiconductor prevents the migration of photogenerated electrons to the surface. The surface electric fields present on the polar mineral crystals can counteract this field to reduce the barrier for electron migration to the surface to take part in redox reactions. This lowering of the barrier is caused by the reduction of the band bending in the space charge layer and an increase in the chemical potential (E_{F}) of the electrons in titania. The polar mineral crystal has oppositely charged ends which can cause the photogenerated electrons and holes to diffuse in opposite directions in a semiconductor, thus enhancing the electron-hole separation. Both the flat band potential (E_{fb}) of titania and the hydrogen reduction reaction follow a Nernstian behavior when pH is varied. The increase in the amount of hydrogen produced at a lower pH is explained by the decrease in the overpotential of the h.e.r. at lower pH values.

According to another aspect of the present invention, the semiconductor material used in forming the photocatalyst can be formed in a manner that enhances the ability of the semiconductor material to generate the desired electron-hole pair orientation at the reactive surfaces of the photocatalyst. The process for creation of the semiconductor material enables the structure of the material to be dominated by crystal faces that have higher photocatalytic activities for reduction, oxidation or both, than prior art semiconductor materials formed in a standardized manner.

According to still another aspect of the present invention, the semiconductor materials formed to optimize the operation of the reactive surfaces on the semiconductor can be incorporated with the polar mineral to increase the quantum efficiency of the photocatalyst utilizing both mechanisms.

Numerous other aspects, features and advantages of the present invention will be made apparent from the following detailed description, taken together with the drawing figures.

### BRIEF DESCRIPTION OF THE DRAWING FIGURES

The drawing figures illustrate the best mode currently contemplated of practicing the present invention.

In the drawings:

FIG. 1 is a schematic view of the stable and excited electronic band structures of a semiconductor;

FIG. 2A is a schematic view of the relative positions of CB and VB with respect to the water redox potentials vs. SHE at pH=0:

FIG. 2B is a graph of the Eh-pH diagram of water:

FIG. 3 is a schematic view of the semiconductor/electrolyte junction before contact:

FIG. 4 is a schematic view of the CB and VB band bending in an n-type semiconductor in contact with an electrolyte;

FIG. 5 is a schematic view of n-type semiconductor/electrolyte junction when the semiconductor is irradiated;

FIGS. 6A-C are diagrammatic views of the various crystal structures of titania;

FIG. 7 is a schematic view of the basic processes occurring in semiconductor photocatalysis;

FIG. 8 is a graph illustrating the solar emission spectrum available for activation of titanium dioxide;

FIG. 9 is a schematic view of a first embodiment of the photocatalyst of the present invention;

FIG. 10 is a schematic view of the pyroelectricity in a tourmaline crystal;

FIGS. 11A-F are transmission electron microscopy images of nanosheets of anatase titanium dioxide;

FIGS. 12A-F are transmission electron microscopy images of nanorods of rutile titanium dioxide;

FIG. 13 is a graph illustrating the evolution of hydrogen over time for a P25 photocatalyst and a P25 photocatalyst integrated with tourmaline;

FIG. 14 is a graph illustrating the evolution of hydrogen from water splitting over time for a P25 photocatalyst and a P25 photocatalyst integrated with tourmaline in a solution of pH 4.8;

FIG. 15 is a graph illustrating the evolution of hydrogen from water splitting over time for a P25 photocatalyst and a P25 photocatalyst integrated with tourmaline in solutions of pHs 9 and 8.5;

FIG. 16 is a schematic view illustrating the reduced band bending and enhanced charge separation in titania in presence of tourmaline;

FIG. 17 is a graph illustrating the electron paramagnetic resonance spectroscopy results for various titania photocatalyst samples;

FIG. 18 is a graph illustrating the formation of CO₂ from the photocatalytic oxidation of acetaldehyde using P25 titania and tourmaline integrated P25 titania;

FIG. 19 is a graph illustrating the hydrogen evolution from water splitting using P25 titania, nanostructured anatase and rutile as photocatalysts;

FIG. 20 is a graph illustrating the formation of CO₂ from the photocatalytic oxidation of acetaldehyde using P25 titania, nanostructured anatase and rutile as photocatalysts;

FIG. 21 is graph illustrating effect of quartz micro-crystals on enhancing hydrogen production of photocatalysts of titania/quartz composites; and

FIG. 22 is graph illustrating effect of quartz micro-crystals on enhancing oxidation of oxidation of acetaldehyde (VOC) of titania/quartz composites.

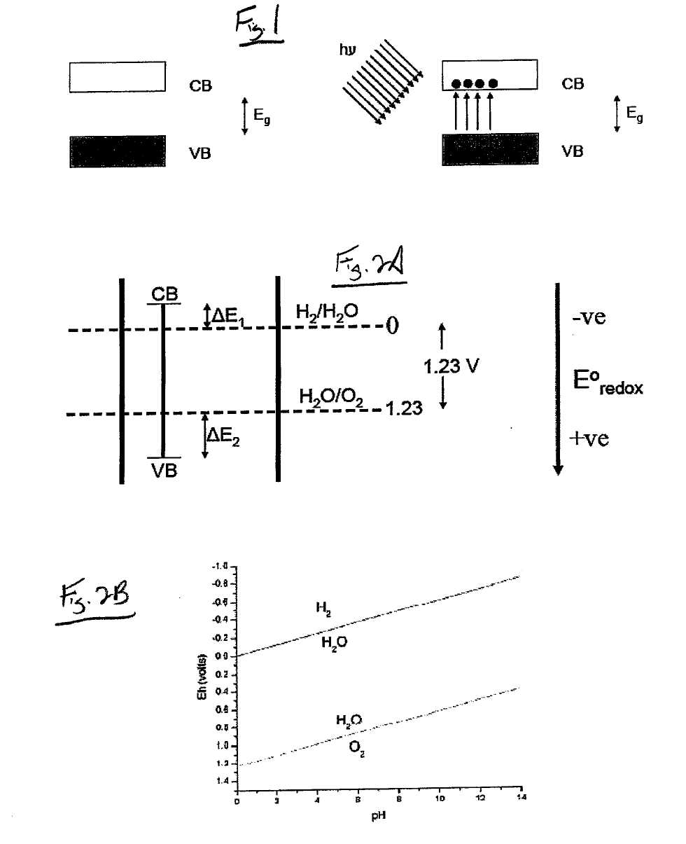

### DETAILED DESCRIPTION OF THE INVENTION

With reference now to the drawing figures in which like reference numerals designate like parts throughout the disclosure, a photocatalyst material formed according to the present invention is indicated generally at 100 in FIG. 9. In a first preferred embodiment of the photocatalyst material 100, the material 100 is formed of a conventional semiconductor material 102 and a mineral material 104.

The semiconductor material 102 can be selected from any materials having known photocatalytic properties, such as semiconductors, and in particular titanium dioxide. This semiconductor material 102 is combined with the mineral material 104 to form the structure of the photocatalyst 100 using any method or process for integrating the semiconductor material 102 and the mineral material 104 with one another. Suitable processes include, but are not limited to, simply mixing the two materials 102, 104 with one another, or by a sol-gel synthesis to produce a photocatalyst 100 having a core/shell structure where the core contains the particles of the mineral material 104 which are coated on the exterior by the semiconductor 102 particles or nanoparticles to form the shell.

The mineral material 104 used in the formation of the photocatalyst 100 is selected from those groups of minerals that have inherent electrical properties, e.g., piezoelectric or pryoelectric properties, that operate to enhance the separation of the electron-hole pairs in the semiconductor material 102 when light is directed onto the semiconductor material 102. Examples of materials of this type that are applicable for use as the mineral material 104 include, but are not limited to, silicates, such as quartz and tourmaline. Preferably, the mineral material 104 is not a ferroelectric material.

Tourmaline belongs to the group of silicate minerals called cyclosilicates. The general chemical formula of the tourmaline group, as a whole, can be expressed as:

XY₃Z₆(T₆O₁₈)(BO₃)₃V₃W, where:
X=Na₊, Ca₂₊, K₊ or vacancy
Y=Li₊, Fe₂₊, Mg₂₊, Fe₃₊, Al₃₊, Cr₃₊, V₃₊, (Ti₄₊)
Z=Al₃₊, Fe₃₊, Mg₂₊, Cr₃₊, V₃₊, (Fe₂₊)
T=Si₄₊, Al₃₊, (B₃₊)
B=B₃₊ or vacancy
V=[O(3)]=OH₋, O₂₋
W=[O(1)]=OH₋, O₂₋, F₋
and ( ) indicates minor or possible substitution.

Some of the important minerals belonging to the tourmaline group are listed below with their chemical formulae:

| | X | Y | Z | |
|---|---|---|---|---|
| Buergerite | Na | Fe3,3+ | Al6 | B3Si6O27(O,OH)3(OH,F) |
| Chromdravite | Na | Mg3 | Cr5Fe3+ | B3Si6O27(O,OH)3(OH,F) |
| Dravite | Na | Mg3 | Al6 | B3Si6O27(O,OH)3(OH,F) |
| Elbaite | Na | (Li,Al)3 | Al6 | B3Si6O27(O,OH)3(OH,F) |
| Ferridravite | Na | Mg3 | Fe6,3+ | B3Si6O27(O,OH)3(OH,F) |
| Liddiocoatite | Ca | (Li,Al)3 | Al6 | B3Si6O27(O,OH)3(OH,F) |
| Schorl | Na | Fe3,2+ | Al6 | B3Si6O27(O,OH)3(OH,F) |
| Uvite | Ca | Mg3 | Al5Mg | B3Si6O27(O,OH)3(OH,F) |

The chemical formulae listed above represent the ideal composition for the corresponding species. But, in reality, there is a limited substitution of other cations in the X, Y, Z sites. The tourmaline used in this work is Elbaite containing Lithium and Aluminum.

Tourmaline belongs to the trigonal or rhombohedral lattice crystal structures with the space group R3m. The cell dimensions of the rhombohedral lattice vary depending on the composition for each of the individual minerals belonging to the tourmaline group. In general, the cell parameter c ranges from 6.86-7.47 A₀ and a ranges from 15.676-16.2 A₀. The range in the cell dimensions of the tourmalines reflects the variation in their composition.

Tourmaline is a hemimorphic rhombohedral borosilicate. It is a true cyclosilicate, consisting of six-membered rings that are not connected to one another by tetrahedra as they are in other cyclosilicates such as beryl. In the six-membered rings, each silicate tetrahedron shares two of its four oxygens with adjacent tetrahedra to form (Si₆O₁₈)₁₂₋ rings. The apical oxygen ions of the six-membered rings point toward the analogous pole (−c) of the crystal, giving tourmaline its hemimorphic nature and polar properties. The six-membered rings are linked to triangular (BO₃)₃₋ groups that lie in the same plane as the tetrahedral rings. The borate groups are oriented a three-fold axis that runs parallel to the c-axis.

Tourmaline crystals have one three-fold rotation axis and three mirror planes all of which are parallel to the c-axis. This symmetry places tourmaline in the ditrigonal pyramidal symmetry class. In this symmetry class, all of the occurring forms are open and a complete crystal in this class is made up of at least two different crystal forms. Because tourmaline forms are open and because the crystals have no center of symmetry, no mirror plane or rotation axes perpendicular to the c-axis, the rotation of axis (in this case the c-axis) is polar. By definition, as shown in FIG. 10, the positive end of the c-axis is called the antilogous pole and the negative end (−c) is called the analogous pole. These limitations on the symmetry of tourmaline necessitate that the top and bottom of a tourmaline crystal always have different forms (hemimorphic).

Tourmaline, like other minerals that possess only a single polar axis of symmetry, exhibits both pyroelectric and piezoelectric properties. Pyroelectricity is the property by which the two terminations of a heated crystal, with a unique but polar rotation axis, are oppositely charged. Upon cooling, the effect reverses. During heating, the analogous end of a tourmaline crystal becomes charged positively while the antilogous end becomes charged negatively. During cooling, after the charges developed during heating have been removed, the analogous end becomes charged negatively while the antilogous end becomes charged positively. Furthermore, when an electric field is applied along the c-axis, heating occurs when the current is directed from the analogous end toward the antilogous end, and cooling occurs if the field is directed in the opposite direction. The intensity of electrical polarity is different for differently colored tourmalines which is the result of the differences in composition.

Both true (primary) and false (secondary) pyroelectricity have been described for crystalline materials. True pyroelectricity can only develop in tourmaline and other crystalline substances having a single polar axis, while false pyroelectricity can develop in any crystalline substance that lacks a center of symmetry, e.g., quartz. False pyroelectricity is, in essence, piezoelectricity developed in response to strains caused by heating and cooling. True and false pyroelectricity cannot be distinguished easily and so the existence of pyroelectric effect can be taken only to indicate the lack of a center of symmetry, not the presence of a polar axis. Also, some minerals that have polar axes do not readily exhibit pyroelectric effects (e.g. Schorl). A permanent electric dipole or spontaneous polarization is inherent along the c-axis of tourmaline. As temperature is varied, the charge distribution in the structure shifts to produce a voltage along this axis. This voltage dissipates as atmospheric molecules are adsorbed onto the surface, so the crystal soon reverts to electrical neutrality. The primary pyroelectric coefficient is a vector property, isolated when the external electric field, applied stress and applied strain on a crystal are constant or zero. However, thermal expansion in a crystal held under such conditions establishes a strain field. Thus, a component of the measured pyroelectric coefficient is caused by the piezoelectric effect. This component, known as secondary pyroelectricity, is important as it produces between 75 and 90% of the observed pyroelectric effect in tourmaline. The experimentally measured pyroelectric coefficient is the sum of primary and secondary coefficients. Tourmaline pyroelectric coefficients are found to be ranging between 1.8-5.4 μC/(m₂.K). Electric fields of the order of 10₆-10₇ V/m exist on the surface of micron-sized tourmaline.

### Experimental

### 1. Preparation of TiO₂ Material

Degussa P25 is a commercially available highly dispersed titanium dioxide powder manufactured by Degussa. It consists of a mixture of anatase and rutile and is produced by the Chloride method. This method involves thermal decomposition (or combustion) of titanium tetrachloride vapor which is formed by reaction of titanium minerals and chlorine gas at 973-1273 K to yield TiO₂. P25 TiO₂ formed by this method possesses sufficient surface area and has fewer defects because of the higher production temperature and is widely used as a photocatalyst.

In addition, well aligned, pure phase anatase and rutile nanosheets are synthesized through a hydrothermal process using a precursor template. The template used is the sheet structure of KₓTiₓLi_{4-x/2}O₈ (denoted KTLO hereafter) which has a layered structure composed of lepidocrocite-type corrugated host layers of edge-shared Ti(IV)O₆ octahedra with Li₊ occupying the Ti(IV) octahedral sites in the host layers and interlayer K₊ ions. The alkali metal ions in KTLO can be extracted by leaching it in an acid solution and the residual titanium sites serve as seeds for the nucleation and growth of titania in acidic medium under hydrothermal conditions. KTLO is synthesized by adding tetrabutyl titanate (Ti(OR)₄) drop wise to a lithium hydroxide (LiOH) aqueous solution under magnetic stirring, followed by the addition of distilled water and a potassium hydroxide (KOH) aqueous solution which acts as the mineralizer. The final mixture is adjusted such that the concentration of KOH is 1 M, and the molar ratios of Li/Ti is 2:8 while maintaining the total concentration [Li]+[Ti]=0.5 mol/L. This feedstock mixture is loaded into a Teflon lined digestion bomb and heated in an oven at 180° C. for 24 hours. The as prepared KTLO product is filtered, washed with distilled water and dried in an oven. The resulting KTLO powder is characterized by X-ray Diffraction (XRD) using a Scintag Pad V diffractometer and Surface Area and Pore size Analysis using a Quantachrome Instruments NOVA4200e Surface Area & Pore Size Analyzer. For hydrothermal synthesis of anatase, 0.3120 g of KTLO is loaded into the Teflon lined digestion bomb and 30 mL of 0.5 M acetic acid (HOAc) is added to it and the whole mixture is heated at 180° C. in an oven for varying amount of times. Rutile is synthesized using 30 mL of 0.5 M hydrochloric acid (HCl) as the solvent instead of the acetic acid and heated in an oven at 180° C. The obtained products of nanocrystalline anatase and rutile are filtered, washed with distilled water and dried in an oven at 60° C.

Transmission Electron Microscopy (TEM) of titania nanostructures is done using a Philips CM 200UT microscope with a spherical aberration coefficient (Cₛ) of 0.5 mm and a point-to-point resolution of 0.19 nm. The TEM is operated in the High-Resolution Transmission Electron Microscope (HRTEM) and the Selected-Area Electron Diffraction (SAED) mode at an accelerating voltage of 200 kV.

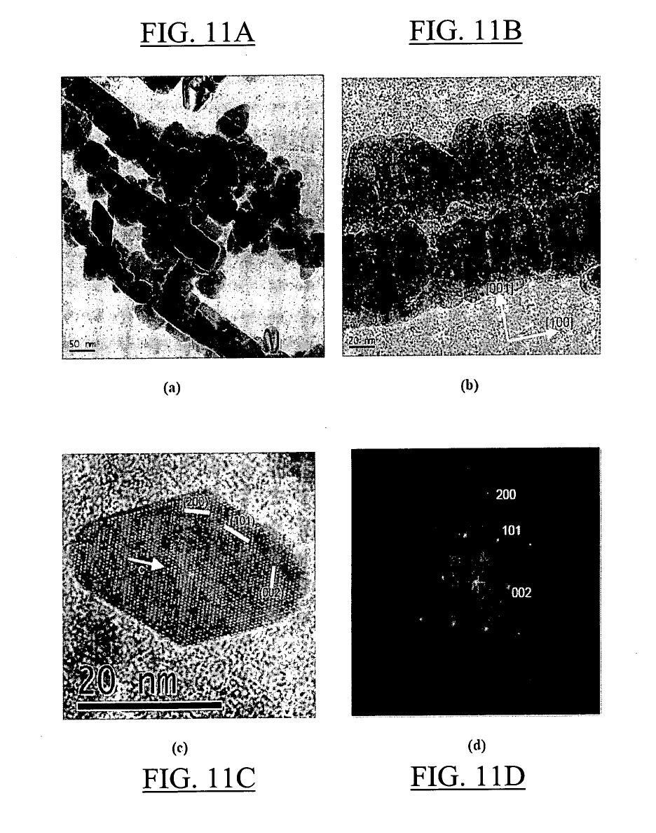

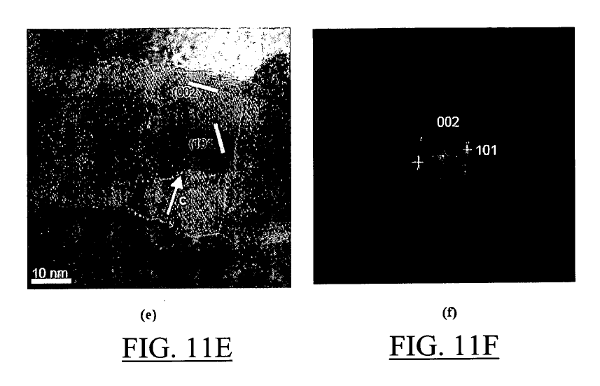

TEM images of anatase nanosheets are shown in FIG. 11A-F. The images show sheets of aligned anatase nanostructures. Based on the orientation of the lattice fringes in the HRTEM images, the orientation of the crystal axes and crystallographic planes can be determined. The measured lattice d-spacing values of the fringes are 1.89 Å, 3.52 Å, and 4.75 Å, corresponding to {200}, {101} and {002} lattice spacing. The viewing direction can determined to be [010] and the particle surface is a (010) plane. Thus the individual nanosheets of anatase can be thought to be grown epitaxially along the [001] direction and aligned or stacked parallelly along the [100] direction to form the anatase nanostructures with a sheet like morphology. The mechanism of formation of these anatase nanostructures can be explained by the plate-like or planar morphology of the KTLO precursor from which anatase nanosheets start to form during the hydrothermal synthesis. As can be seen from the images, the nanosheets are about 30 nm wide and 50 nm long.

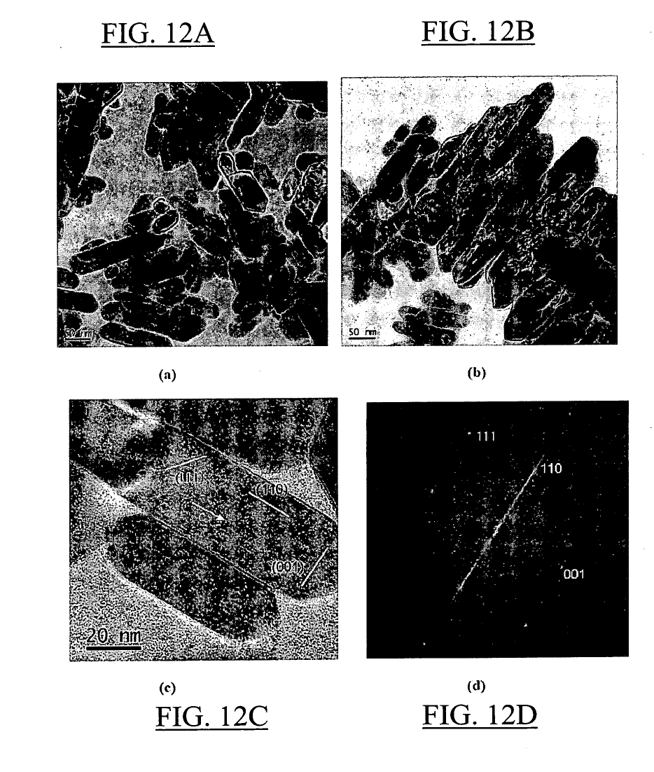

TEM images of aligned rutile nanorods are shown in FIG. 12A-F. Based on the orientation of the lattice fringes in the aligned rutile nanorods, the orientation and the direction of growth of the nanorods are determined. The long axial orientation of the rutile nanorod is along the [001] direction. The lattice spacing of the fringes is measured to be 3.25+0.02 Å which corresponds to the {110} lattice planes of rutile crystal. The strong (110) diffraction spots compared to other diffraction spots from the lattice fringes indicate that the nanostructures are dominated by {110} crystal planes. The nanorods are about 100-150 nm in length and 30 nm in width and a couple of nanometers in thickness.

### 2. Preparation of Mineral Materials

Tourmaline powder is obtained by crushing and grinding a naturally available elbaite crystal. Very fine powder of tourmaline powder is obtained by the sedimentation technique. The ground tourmaline powder is dispersed in a beaker of water. The smaller (lighter) particles get suspended in the liquid while the heavier particles sink to the bottom of the beaker. The smaller particles are collected by filtration and the larger particles are again ground to obtain further finer powder and the process is repeated until very fine tourmaline powder with a narrow size distribution is obtained. From the SEM images, the tourmaline particles are found to have a size ranging from 1-5 microns.

### 3. Photosplitting of Water

### a.) Procedures

The photosplitting of water experiments are carried out in quartz tubes of dimensions 14×16 mm (I.D.×O.D.) and of length of about one feet which can be fitted with a rubber stopper at the open end to create a closed system for gases. The quartz tubes are transparent to UV light. A certain amount of the photocatalyst (titania and titania plus tourmaline) is weighed carefully and loaded into the quartz tube and 5 ml of water is added to it. The quartz tube is then closed with a rubber stopper and capped using crimps. The tubes are then flushed with dry nitrogen gas to remove the oxygen present inside and create an inert atmosphere. The tubes are placed on a shaker moving at 100 rpm and are exposed to UV light from a lamp. The source of UV light is a Spectroline ENF 280C equipped with one 8 W long wavelength (365 nm) tube with LONGLIFE filter assembly. The intensity of the light emitted is about 470 μW/cm₂ at a distance of 15 cm. Gas samples are collected periodically from the tubes using 1 mL syringes, for hydrogen analysis. For experiments using ascorbic acid as the electron donor, 5 mL of 200 mM of ascorbic acid solution is added to the photocatalyst in the tubes instead of water.

The amount of hydrogen gas from the photosplitting experiments is measured with an AMETEK Trace Analytical ta3000 Gas Chromatograph. The ta3000 Gas Analyzer is an isothermal gas chromatograph configured with a Reduction Gas Detector (RGD) sensor for detection of hydrogen. The operating principle of the RGD is based upon the strong absorption of UV light by mercury vapor. As a reducing species like hydrogen passes through a heated mercuric oxide bed in the detector, mercury vapor is released in direct proportion to its concentration in the sample gas. The amount of mercury vapor can be measured by its UV absorption by a photometric cell. The carrier gas used is nitrogen of 99.99999% purity at a flow rate of 20 cc/min. The detection limit of the instrument is 10 ppb hydrogen.

### b.) Results

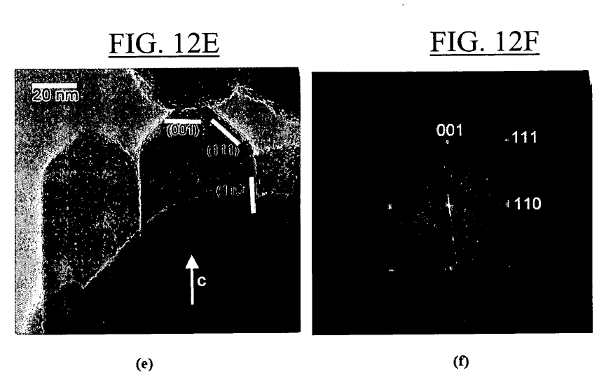

Photosplitting of water experiments were done with P25 titania, P25 titania integrated with tourmaline, nanostructured anatase and rutile phases as the photocatalysts in a solution of pure water, water at different values of pH and ascorbic acid. FIG. 13 shows the hydrogen production in parts per billion (ppb) using 5 ml of pure water as the solution. 0.02 g of P25 titania (P) is used when the photocatalyst is used alone, and 0.02 g of P25 titania is combined with an equal amount of tourmaline powder for the second system (P+T). Hydrogen production from water increased considerably when P25 titania is combined with tourmaline powder compared to using P25 titania alone. The rate of hydrogen evolution follows a trend where the rate is very high initially and gradually declines after 2 hours. The increase in the amount of hydrogen produced is not monotonic. This is due to the back reaction of hydrogen and oxygen combining to form water again. Back reaction to form water is highly undesirable and is one of the biggest problems encountered in photochemical synthesis of hydrogen from water, since the reaction is energetically favorable.

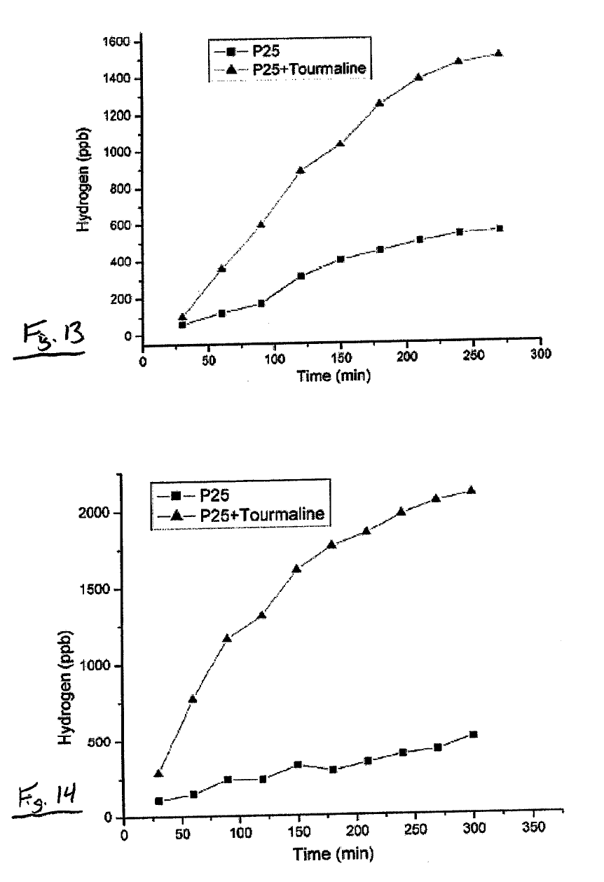

FIG. 14 shows the evolution of hydrogen using a solution of pH 4.8 with the photocatalysts. The solution pH is controlled through addition of 0.1 N HNO₃. The increase in the amount of hydrogen produced in the (P+T) system compared to using P25 alone is much more enhanced at a low solution pH than in pure water. The amount of hydrogen produced is as high as 2 ppm in the (P+T) system.

FIG. 15 shows the hydrogen evolution in systems containing solutions of alkaline pHs of 8 and 9.5. The amount of hydrogen produced in the (P+T) systems is still higher than systems using P25 alone, but the total amounts of hydrogen produced are considerably lower to systems containing solutions of neutral or acidic pHs.

The reactions involved in photosplitting of water to produce hydrogen are:

4h++2H2O(liq)→O2(gas)+4H+(anodic)

4H++4e−→2H2(gas)(cathodic)

The overall reaction can be written as:

2H2O(liq)+4e−→O2(gas)+2H2(gas)

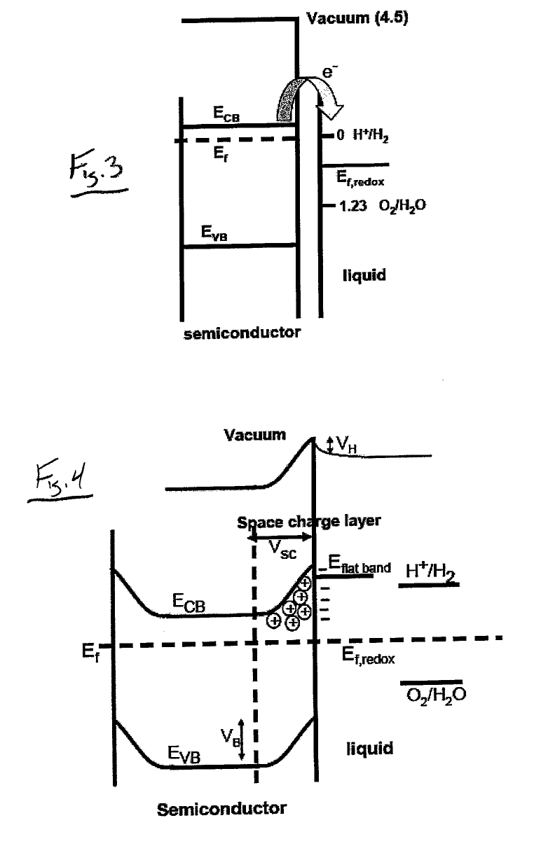

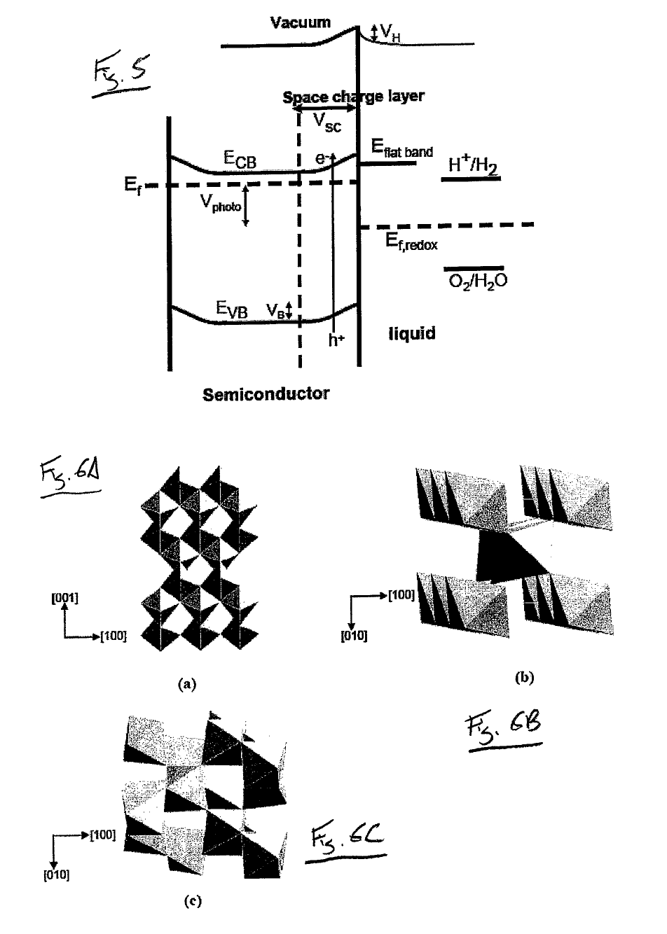

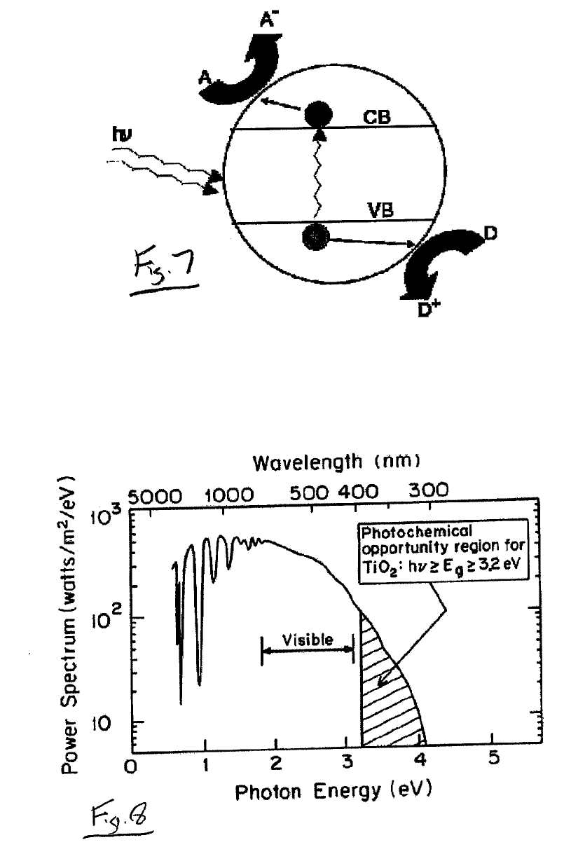

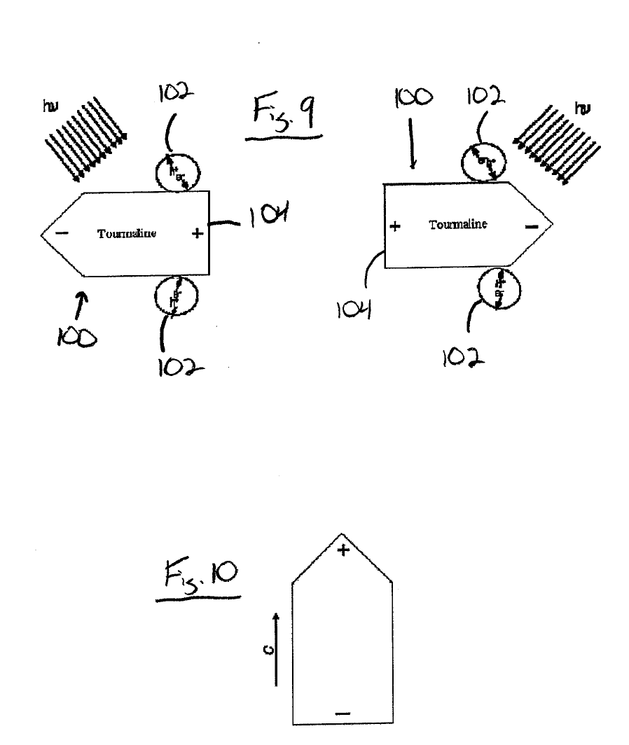

The above reaction proceeds when 4 charge carriers diffuse from the interior of the semiconductor particle onto the surface to reduce or oxidize the adsorbed species. The electromotive force (EMF) generated by this reaction as calculated from the value of standard free energy ΔG°_{(H2O)} is 1.23 eV. The redox potential of the cathodic (H₂O/H₂) and the anodic (O₂/H₂O) half cell reactions vary with the pH according to the Nernst equation as shown on the Eh-pH diagram in FIG. 2B. The cathodic reactions varies as:

Eh=−0.0592 pH;

and the anodic half cell reaction varies as:

Eh=1.23−0.0592 pH.

So the redox potentials shift to more negative values (higher on the electrochemical scale) as pH increases. As explained previously, for water reduction to occur at the semiconductor/liquid interface, the conduction band has to be more negative than the redox potential of H₂O/H₂. Only a few semiconducting materials such as TiO₂, CdS and SrTiO₃ satisfy this condition. For an n-type semiconductor like TiO₂, a space charge layer forms at the semiconductor/electrolyte and the electric field in this layer prevents the transfer of electrons from the interior of the semiconductor to the interface. When the interface is irradiated, the band bending at the interface is reduced and E_{F} is moved towards the flat band potential. For electron transfer to occur from the semiconductor to the redox species, the chemical potential (E_{F}) of the electrons in the semiconductor should be greater (higher) than the chemical potential of the electrons in the redox species (E_{F,redox}). If this condition is satisfied, electrons can migrate from the bulk of the semiconductor onto the surface where they can reduce the H₊ ions to hydrogen gas.

For P25 titania, the conduction band edge is just above the redox potential for H₂O/H₂. As a result, the driving potential for the reduction reaction which is defined as the difference in potential between the conduction band minimum and the redox potential of H₂O/H₂, is very much less. Also because of the band bending inside the semiconductor, the chemical potential of the electrons generated in the interior of the semiconductor particle might actually be lower than the H₂O/H₂ redox potential, such that the electrons may not be able to thermodynamically reduce the H₊ ions to produce hydrogen. These two factors can explain the observed low amounts of hydrogen produced using P25 titania alone as the photocatalyst.

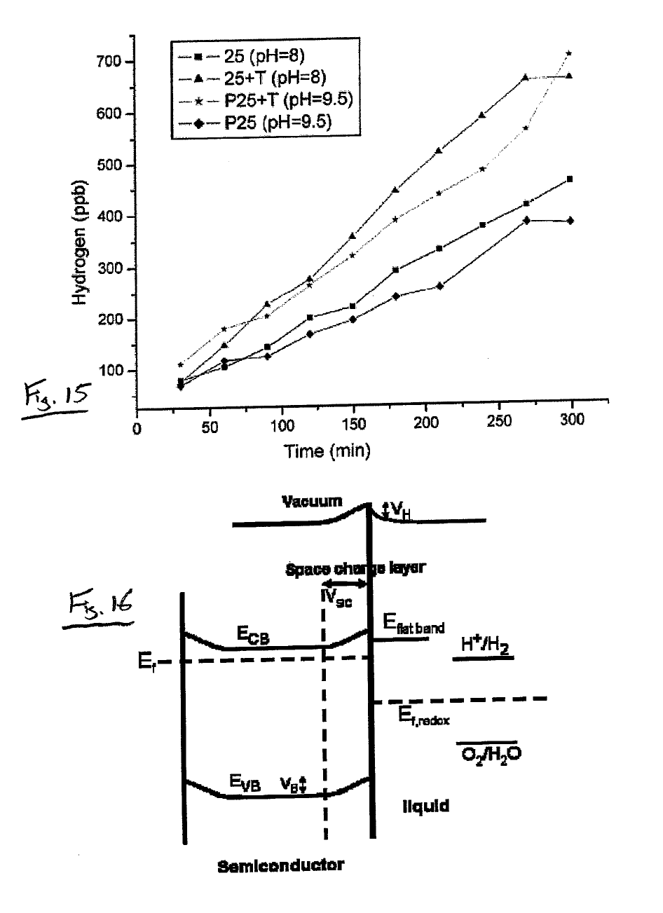

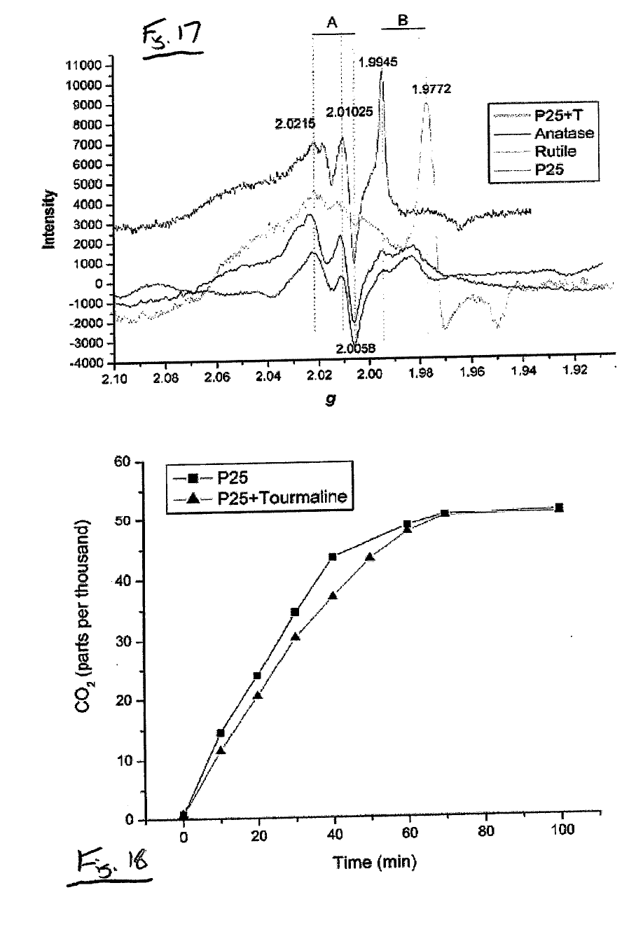

When P25 titania is integrated with tourmaline particles and employed as the photocatalyst, the amount of hydrogen produced increased considerably, more than by a factor of 2. Tourmaline is a polar mineral and has surface polarization at ambient temperatures. Each crystal or particle has two poles or regions of opposite charge at the ends. These surface electric fields on tourmaline can replicate the Schottky effect on metal/semiconductor junctions where in the barrier potential for the migration of charge carriers to the surface semiconductor is reduced by an applied external electric field. This is qualitatively shown in FIG. 16 where in the presence of tourmaline, the band bending in titania semiconductor particles is reduced and the conduction band in the interior of the semiconductor moves upwards. The barrier potential in titania is reduced from E_{B} to E_{B1} in presence of tourmaline. Thus the chemical potential of the electrons (E_{F}) photogenerated inside the semiconductor is higher than the H₂O/H₂ redox potential, and the electrons can thermodynamically reduce the H₊ ions adsorbed on the surface of the semiconductor to produce hydrogen gas.

In simplest terms, the effect of surface polarization of tourmaline on titania can be explained by the opposing charges present at the either ends of tourmaline particle. For the semiconductor particles attached to the positively charged end, the electrons generated inside the semiconductor migrate outwards towards this surface, while the photogenerated holes migrate outwards towards the opposite surface. Thus the electrons and holes are driven to different locations, and consequently oxidation and reduction reactions are spatially separated. The process occurs conversely in the semiconductor particles attached to the negatively charged end towards which the holes migrate while the electrons migrate outwards towards the opposite surface. Thus more charge carriers are available for the redox reactions and hence the amount of hydrogen produced is substantially higher than in systems containing just the semiconductor photocatalyst P25.

From the figures above, it can be seen that the amount of hydrogen produced increases when the pH of the solution is 4.8 and the amount of hydrogen decreases when a more alkaline pH (8 and 9.5) is used compared to the system using pure water. As given by the equations illustrated above, the redox potentials of H₂O/H₂ and O₂/H₂O change as pH is increased. The flat band potential of the semiconductor is also demonstrated to show Nernstian behavior as pH is varied:

E_{CB}=E_{CBO}−0.0592 pH

Thus the driving potential which is the difference between the CB minimum and the redox potential remains constant as pH is varied. This could lead to the conclusion that the amount of hydrogen produced should not change even as the pH of the solution is varied. But there are other factors which should be considered when the pH of the solution is changed. At lower pH values, the size of the titania agglomerates increases resulting in a reduction in the surface area which can lower the photocatalytic reactivity. But as pH is lowered, the concentration of H₊ in the solution increases and the coverage of hydrogen increases. Also, the overpotential of the hydrogen evolution reaction (h.e.r) which is the kinetic barrier to the electrode potential, is lower at lower values of pH and is higher at higher values of pH. The overpotential of an electrode is defined as the difference between the operating potential and the equilibrium potential. When the overpotential is low, the reaction on the electrode can proceed at potentials closer to the equilibrium potentials and represents a kinetic barrier to the reaction. Hence when the overpotential of the h.e.r is low, the amount of hydrogen produced is higher than when the overpotential of h.e.r is high in solutions of alkaline pHs.

Also titania is an amphoteric oxide which upon addition to pure water decreases the pH slightly. However, this temporal variation in pH does not affect the hydrogen evolution much. At lower pH, the surface of the oxide is covered with hydroxyl ions which results in the observed decrease in the pH. Taking into effect all these factors, pH values between 4.5 and 7 are shown to be the optimal range for hydrogen evolution. This explains the increase in the amount of hydrogen produced when solutions of pH 4.8 and pure water compared to the solutions with a higher pH values.

### 4. Photocatalytic Oxidation (PCO) of Acetyldehyde

### a.) Procedures

The photocatalytic oxidation of acetaldehyde is carried out in quartz tubes of dimensions as described above which can be fitted with a rubber stopper at the open end to create a closed system for gases. The oxidation experiments are performed with films of titania as the photocatalyst. Titania films are made from an aqueous slurry containing 5 weight % photocatalyst. For experiments using titania integrated with fine-grained tourmaline or quartz as the photocatalyst, a 1:1 weight ratio of titania and tourmaline (or quartz) is used with the weight % of titania in the aqueous slurry being 5%. The photocatalyst films are made by coating one side of thin glass slides (dimensions 280×10×2 mm) with 2 ml of the aqueous slurry and drying them in an oven at 60° C. These glass slides are then placed inside the quartz tubes and sealed with a rubber stopper and capped using crimps. The quartz tubes are then flushed with oxygen gas for 10 minutes to create an oxidizing atmosphere inside.

Acetaldehyde is a volatile organic compound with a boiling point (21° C.) below the room temperature. Acetaldehyde used for the experiments is obtained from Fisher Scientific and is stored in a refrigerator in liquid form in a bottle. A stock gaseous mixture of acetaldehyde is made separately in a 100 mL glass bottle. The glass bottle is sealed with a rubber stopper and flushed with dry nitrogen for 10 minutes to remove the oxygen present inside. The glass bottle is then placed in a tray containing ice to cool it to zero degrees temperature. A 1 mL syringe with needle is also placed in the tray to be cooled down to the zero degrees. The acetaldehyde bottle is taken out from the refrigerator and placed in the tray containing ice. 0.5 mL of acetaldehyde liquid is injected with the syringe into the stock bottle. The stock bottle is then taken out from the tray with the ice to allow it to warm upto room temperature. The acetaldehyde in the bottle vaporizes at room temperature and expands to fill the glass bottle. (0.5 mL of acetaldehyde liquid expands to about 216 mL of gaseous acetaldehyde at 25° C. assuming ideal gas behavior). Before the bottle is taken out of ice, the rubber stopper is pierced with a syringe needle fitted to one end of a long rubber tube and the other end of the rubber tube is immersed in a beaker containing water. As the bottle warms up to room temperature, acetaldehyde vaporizes and expands inside the bottle. The nitrogen inside the bottle is expelled through the syringe needle which is bubbled through the water in the beaker. Once the bubbling of the gas stops, the pressure inside the bottle reaches atmospheric pressure and the syringe needle is removed from the stock bottle containing pure acetaldehyde gas.

For the oxidation experiments, 1 mL of acetaldehyde gas from the stock bottle is injected into the quartz tubes containing the photocatalyst films and filled with oxygen gas. The tubes are then exposed to the UV light of wavelength 365 nm. Gas samples are collected periodically from the tubes using a 100 μL syringe and analyzed in a Gas Chromatograph (GC).

The electron Paramagnetic Spectroscopy (EPR) or Electron Spin Resonance (ESR) spectroscopy technique is used to detect paramagnetic species i.e. species with unpaired electrons, generally free radicals. The basic physics of this technique is similar to NMR (Nuclear Magnetic Resonance), but instead of the spins of the atom's nuclei, the electron spins are excited. An electron has a magnetic moment, which when placed in an external magnetic field of strength B₀, aligns itself parallel (lower energy) or anti-parallel to the external field (higher energy). This is called Zeeman effect and the energy separation between these two states is given by:

ΔE=gₑμ_{B}B₀

where gₑ is the gyromagnetic ratio of the electron (the ratio of its magnetic dipole moment to its angular moment) and μ_{B} is the Bohr magneton. An electron can resonate between these two states by absorption of electromagnetic radiation of energy ∪hE=Δ. A free electron (on its own) has a g value of 2.002319304386 (which is gₑ, the electronic g factor). EPR signals can be generated by changing the magnetic field B₀ at a constant frequency (∪) radiation and measuring the energy absorption to obtain a series of sharp peaks and troughs corresponding to different values of g at different magnetic field strengths. EPR can be used for the identification and quantification of radicals, to identify the reaction pathways involving radicals in photocatalytic reactions. EPR measurements are performed using a Bruker ER 300 EPR Spectrometer operating at X-band with a TM₁₁₀ cavity. The instrument settings used are: modulation amplitude 5-10 G, time constant 5 ms, modulation frequency 100 kHz, microwave power 1-2 mW, microwave frequency 9.35 GHz and a center field of 3300 G. The samples were placed in a quartz EPR cell and immersed in liquid nitrogen in a quartz insert Dewar (77 K) and irradiated with an 8 W UV lamp through the irradiation slots of the EPR cavity.

The amount of carbon dioxide (CO₂) gas from the photocatalytic oxidation experiments is measured with a Shimadzu GC-14A gas chromatograph equipped with a Flame Ionization Detector (FID) with methanizer. In gas chromatography, a gas sample is swept by a carrier gas through a column packed with a material that the different gases in the sample have different affinities for and so elute out at different times. The carrier gas used is He with a mass flow controller and the fuel gas is a mixture of air and H₂. When CO₂ elutes from the column, it is mixed with H₂ and passed over hot zinc in the methanizer where it is reduced to CH₄. The CH₄ is burnt to CO₂ in the H₂ flame and the current produced between the anode and the cathode of the FID can be measured to give the amount of CO₂ in the sample. The detection limit of the instrument with the above settings is 20 parts per thousand of CO₂ gas.

### b.) Results

EPR (ESR) spectroscopy has been widely used to examine paramagnetic species on TiO₂ surfaces, particularly with the objective of identifying radicals formed under UV irradiation which are important in photocatalytic processes. In the process of photocatalysis, the electrons and holes generated in the irradiated particles are trapped at the surface, forming paramagnetic species. The photocatalytic reactions arise from the reaction of these radicals with some reactant molecule at the TiO₂ surface. The photogenerated electrons may be trapped at several sites; titanium atoms on the surface or inside the particles, or oxygen molecules adsorbed on the surface. The photogenerated holes can be trapped at the oxygen atoms in the crystalline lattice near the particle surface or at the hydroxyl groups on the surface. FIG. 17 shows the ESR spectra obtained at 77 K from P25 titania, P25 titania with tourmaline, nanostructured anatase and rutile synthesized by the hydrothermal method.

The ESR signals are labeled as signals A and B. They are characterized by the sets of g values g₁=2.0058, g₂=2.01025, g₃=2.0215 from signal A and g₁=1.9945, g₂=1.9772 from signal B. Both P25 titania and P25 titania integrated with tourmaline have strong signal A and a weak signal B. Rutile nanoplates have a very high intensity from signal B, but have a very weak signal A. Nanostructured Anatase has high intensities of both signals A and B. A review of the literature suggests that signal A can be attributed to the holes trapped on or near the particle surface, and signal B can be attributed to electrons trapped at the particle surface.

In anatase, photoproduced holes are trapped at the lattice oxygen atoms located in the subsurface layer of the hydrated anatase. This radical has the structure Ti₄₊O₋.Ti₄₊OH₋ and has the set of g values g₁=2.004, g₂=2.012, g₃=2.016. Signal A corresponds well to this signal in the g values and the shape, and the surface of the samples are covered with hydroxyl groups. From this consideration, signal A can be assigned to the Ti₄₊O₋.Ti₄₊OH₋ radical. This shows that the surface hydroxyl group plays an important role in photocatalytic oxidation reactions.

Signal B originates from the electrons trapped at or inside the particle surface. It was reported that Ti₃₊ is formed on TiO₂ powders by trapping the photogenerated electrons. The g values of Ti₃₊ were reported to be below 2. The g values of 1.9945 and 1.9772 from signal B can be attributed to Ti₃₊. The difference between the g values of the surface Ti₃₊ and those of the inside Ti₃₊ are very small. Although it is difficult to predict the location of Ti₃₊ radicals only from the g values, it is generally assumed that Ti₃₊ formed inside the particles acts as a recombination center and reduces the activity of the photocatalyst whereas the Ti₃₊ formed on the surface of the particles increases the photoactivity.

P25 titania is a mixture of anatase and rutile, dominated by the anatase component (84%). Both P25 titania and P25 titania integrated with tourmaline show a strong signal A which arises from the trapped holes and a weak signal B which arises from the trapped electrons. Thus it can be expected that both these samples show a higher activity for photocatalytic oxidation compared to photocatalytic reduction, because of the presence of excess trapped holes. Rutile nanoplates show a weak signal A, but a very strong signal B suggesting that the rutile particles have excess trapped electrons at the surface which can take part in the photocatalytic reduction reactions. Anatase nanostructures show strong signals of both A and B indicating that a large number of photogenerated holes and electrons are trapped near the particle surface which can undergo oxidation and reduction reactions. Thus the anatase sample is expected to show a high activity for both photocatalytic reduction and oxidation reactions.

From the ESR spectra in FIG. 15, it can be seen that nanostructured anatase sample shows very strong signals A and B whereas the rutile sample shows a very strong signal B, but a weak signal A. P25 titania and tourmaline integrated P25 titania photocatalysts show a strong signal A, but a very weak signal B. As explained previously, signal A arises from the trapped holes on the surface of the photocatalyst particle which take part in the oxidation reactions whereas signal B arises from the trapped electrons on the photocatalyst surface sites which take part in the reduction reactions. It can be inferred from the ESR spectra that nanostructured anatase will show a high activity for both oxidation ad reduction reactions since it has strong signals A and B, nanostructured rutile will show a high activity for reduction because of the presence of a strong signal B, but a moderate or weak activity for oxidation because of a very weak signal A. P25 titania is expected to show a high activity for oxidation because of strong signal A, but a very low activity for reduction because of a very weak signal B. Photochemical reactivity of anatase and rutile depends on the surface orientation (hkl of the surface on which the redox reaction is taking place) of the photocatalyst particle or the film. Different surface energy levels of the conduction and valence bands are expected for different crystal faces of TiO2 because of the atomic arrangements characteristics of the faces. The difference in the energy levels drives the electrons and holes to different crystal faces, leading to separation of electrons and holes resulting in different photocatalytic activities for different crystal faces. It has been concluded that the oxidation and reduction sites on rutile particles are on the {011} and {110} faces respectively, and, on {001} and {011} face respectively for anatase particles. These surfaces are thought to be especially reactive because of the presence of four-coordinate and five-coordinate Ti atoms on faces due to surface termination, which can act as surface reaction sites. P25 titania is a mixture of predominantly anatase and rutile phases with the bulk particles having random surface orientations. Nanostructured anatase is dominated by the {101}, {001} and {100} crystal faces whereas the rutile nanorods are dominated by the {110} and {001} crystal surfaces.

The conduction and valence bands of anatase TiO₂ occur at −0.1 and +3.0 V respectively vs. SHE; i.e. the holes generated by light excitation are very powerful oxidants. Acetaldehyde is a common contaminant in indoor air and is also formed during PCO of ethanol. Acetaldehyde can be mineralized completely to produce CO₂ as the final product by photocatalytic oxidation. FIG. 16 shows the formation of CO₂ from the oxidation of acetaldehyde on photocatalyst films made of P25 titania and P25 titania integrated with tourmaline. The levels of CO₂ in the atmosphere are about 380 ppm, and in the laboratory, they are about 600-700 ppm.

The amount of CO₂ formed is very similar in case of both the photocatalysts, with the P25 titania being slightly more active and producing more CO₂ in the initial period. Both photocatalysts are very active initially and the rate of CO₂ formation gradually decreases. As discussed previously, the ESR signal A from trapped holes in photocatalysts P25 titania and P25 titania with tourmaline is substantial indicating they can be very powerful catalysts for PCO. The trapped holes react with the surface hydroxyls to form the hydroxyl radicals. One of the proposed mechanism for PCO of acetaldehyde is direct decomposition to CO₂ according to the following reactions:

*OH₋+h+→OH

CH3OCHO+OH*→CH3C*O+H2O

CH3C*O+O2→CH3C(O)OO*

2CH3C(O)OO*→2CH3C(O)O*+O2

CH3C(O)O*→CH3*+CO2

Another minor reaction mechanism involves through the formation of acetic acid:

CH3CHO+OH*→[CH3CHOHO*]a*

[CH3CHOHO*]a*→CH3CHOHOa*

CH3CHOHOa*+O2→CH3COOH+HOO*

The water molecules adsorbed on the surface of the photocatalysts causes band bending in the semiconductor as explained previously. This band bending pushes the valence band lower or more positive on the electrochemical scale increasing greatly the oxidation potential of the photogenerated holes. But in presence of tourmaline, the surface electric fields present on tourmaline crystals reduce the band bending in the semiconductor slightly. So the oxidation potential of the photogenerated holes is slightly reduced. This explains the amount of CO₂ formed, being a little lower in the initial period of PCO when using P25 titania with tourmaline as the photocatalyst compared to using P25 titania alone. But the decrease in the band bending of the semiconductor due to polarity of the tourmaline grains is very small compared to the overall oxidation potential (˜3 eV) of the holes that this effect is very little. Eventually, the amount of CO₂ formed is comparable to that formed using P25 titania alone as the photocatalyst. Acetaldehyde can be completely mineralized to CO₂. The acetaldehyde decomposition reaction is

CH3OCHO+5/2O2→2CO2+2H2O

The amount of acetaldehyde is added is 1 mL (˜25 parts per thousand). The amount of CO₂ formed is very little after the initial rapid rate of formation. This is due to the decomposition of all the acetaldehyde and there is no more acetaldehyde available for consumption. Photocatalysts can be deactivated after a certain time resulting in no formation of any more CO₂. This deactivation of catalysts is due to the poisoning of the catalyst. This poisoning of the catalyst is thought to be due to the decomposition of acetaldehyde to form stable surface species on titania or the due to the formation of trimeric condensation products, higher molecular weight compounds and coke by the reaction of the methyl radical with acetaldehyde.

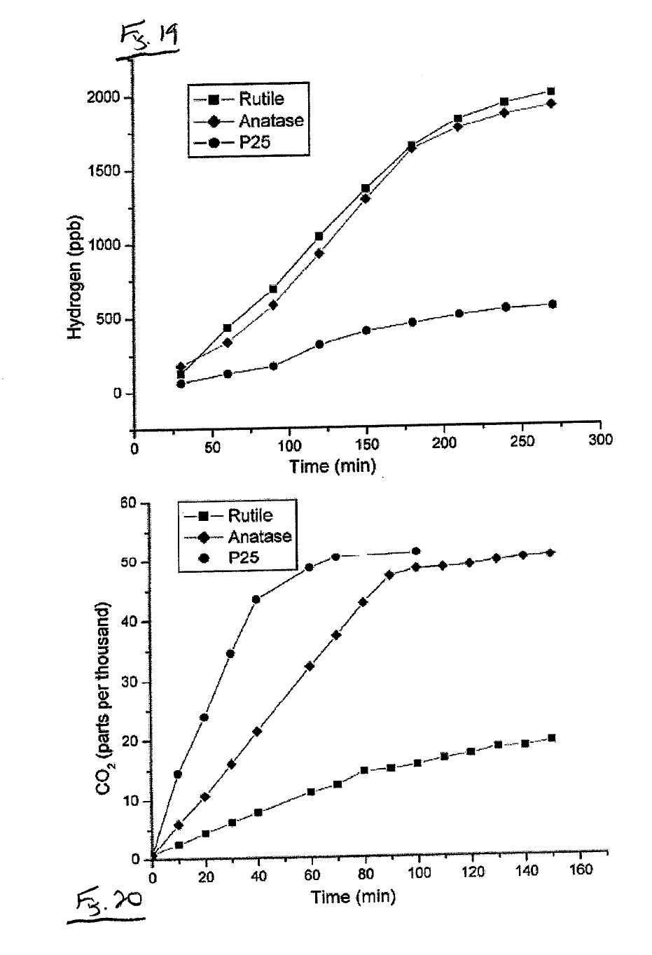

FIG. 19 shows the evolution of hydrogen from pure water when nanostructured anatase and rutile are used as the photocatalysts. For reference, the amount of hydrogen evolved with P25 titania is also included. The amount of hydrogen evolved and the rate of hydrogen evolution are similar for anatase and rutile though rutile is marginally more active than anatase. The amount of hydrogen evolved is also higher than with tourmaline integrated P25 titania photocatalyst and a lot higher than with the P25 titania photocatalyst. In fact, the maximum amount of hydrogen evolved with nanostructured anatase and rutile (2000 ppb) is about 4 times higher than the maximum amount of hydrogen (500 ppb) evolved with the P25 titania photocatalyst. The rate of hydrogen evolution is high initially and gradually decreases with time.

FIG. 20 shows the formation of CO₂ during PCO of acetaldehyde by nanostructured anatase and rutile phases. For reference, PCO of acetaldehyde using the P25 titania is also included. The anatase nanosheets show a very high activity for oxidation of acetaldehyde and a high initial rate of formation of CO₂. In contrast, the rutile phase shows only a moderate activity for the oxidation to CO₂ and the rate of formation of CO₂ is very less compared to the anatase phase. The rate decreases gradually with time for both the anatase and rutile. In case of anatase, the formation of CO₂ decreases because of the complete mineralization of acetaldehyde while in case of rutile, the formation of CO₂ decreases even when there is acetaldehyde present in the tube. This is probably due to the deactivation of the rutile photocatalyst in the manner described in the previous section.

The results of oxidation and reduction experiments presented above agree well with the conclusions for nanostructured anatase and rutile photocatalysts based on the EPR data obtained on these photocatalysts. The morphology of anatase particles is dominated by {001} and {100} crystal faces and thus shows a strong photocatalytic activity for both oxidation and reduction reactions as evidenced by the strong signals A and B in the ESR spectrum and the results in the photosplitting of water and PCO of acetaldehyde. Thermodynamically stable anatase crystals are dominated by {101} faces that are symmetry identical and less reactive. The morphology of rutile phase is dominated by {110} and {001} crystal faces which show a high activity only for reduction reactions as evidenced by a strong signal B and a weak signal A in the ESR spectrum and the results in the photosplitting of water and PCO of acetaldehyde.

Thus, the quantum efficiency of a photocatalyst can also be increased by the production of the semiconductor/photocatalyst material in a manner that provides a nanostructure having crystal faces with the desired activity.

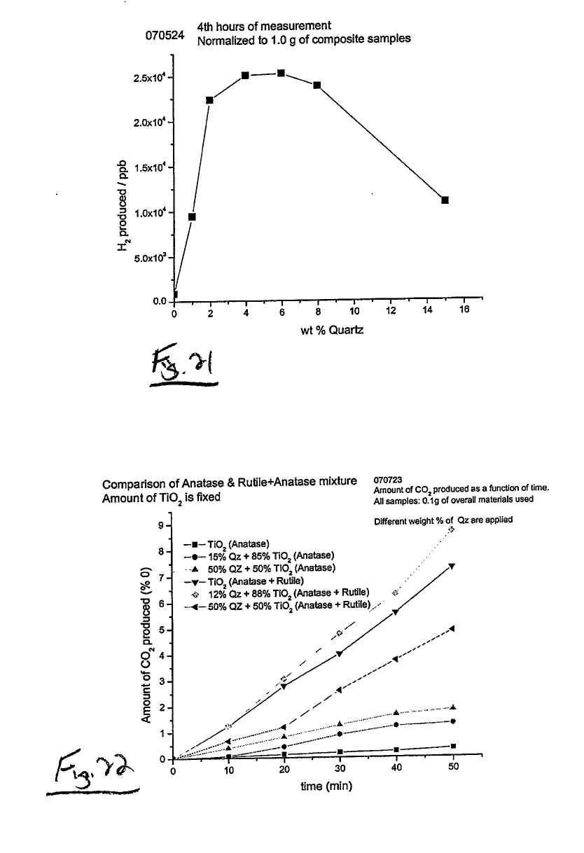

The results from quartz-titania composites also indicate coated quartz crystals can enhance both hydrogen production from water (FIG. 21) and photocatalytic oxidation of VOCs (FIG. 22). Coating either quartz micro-crystals or tourmaline micro-crystals will enhance the photocatalytic reaction, and reduce amount of photocatalysts.

Other applications of the present invention involve the use of sol-gel synthesis to produce photocatalysts having a core/shell structure where the core contains the quartz or tourmaline particles which are coated on the outside (shell) with the titania nanoparticles, photocatalysts coated on micro-crystals of quartz and tourmaline, and composites of photocatalysts with micro-crystals with electrical polarity. This way, the effect of the electrical polarity of tourmaline or quartz particles can be spread across as many titania nanoparticles as possible. Or increased performance of the photocatalysts in photoreduction and photooxidation processes. Another area of application of the present invention is in the field of photo-voltaic (PV) solar cells where the effect of these polar minerals on the efficiency of the cell will improve the performance of the solar cell. Solar cells use solar energy to produce electricity by spatial separation of the photogenerated electrons and holes in the semiconductor material. The electrical polarity of tourmaline and quartz can enhance the electron-hole separation and increase the efficiency of the cell considerably.

Still other applications of the present invention involve increasing the photon-efficiency in titania in addition to the increase in quantum efficiency accomplished in the present invention. Titania is a wide band gap semiconductor and can absorb only a small portion of the solar spectrum. Photon efficiency can be increased by reducing the band gap by doping or increasing the absorption of light of longer wavelengths. The effect of doping transition metals like Ni, Cu, Nb, N etc into titania (anatase and rutile) or titania nanotubes to produce an additional absorption peak in the visible light wavelength range can be incorporated into the photocatalysts of the present invention using the polar mineral materials and the nanostructured anatase and rutile titania components.

Various additional embodiments of the present invention are contemplated as being within the scope of the following claims, particularly pointing out and distinctly claiming the subject matter regarded as the invention.

1. A photocatalyst composition comprising:
a) a core formed of a mineral material having an intrinsic electrical polarity; and
b) a shell disposed at least partially around the core, wherein the shell is formed from a semiconductor photocatalyst material.

2. The composition of claim 1 wherein the core is formed from a silicate material.

3. The composition of claim 2 wherein the core is formed from quartz.

4. The composition of claim 2 wherein the core is formed from tourmaline.

5. The composition of claim 1 wherein the shell is formed from an oxide semiconductor photocatalyst material.

6. The composition of claim 5 wherein the shell is formed from titanium dioxide.

7. The composition of claim 6 wherein the shell is formed from nanostructured anatase.

8. The composition of claim 6 wherein the shell is formed from rutile nanorods.

9. A method for forming a photocatalyst material, the method comprising:
a) providing a core formed of a non-ferroelectric, mineral material; and
b) forming a shell over at least a portion of the core, the shell formed from a semiconductor photocatalyst material.

10. The method of claim 9 further comprising the step of forming the semiconductor photocatalyst material in a hydrothermal process.

11. The method of claim 9 wherein the step of forming the shell over at least a portion of the core comprises performing a sol-gel process to position the shell around at least a portion of the core.

12. A process for initiating a heterogeneous photocatalytic reaction, the process comprising:
a) providing a photocatalyst composition including a core formed of a silicate material and a shell disposed at least partially around the core, wherein the shell is formed from a semiconductor photocatalyst material; and
b) directing light energy at the photocatalyst.

13. The method of claim 12 wherein the photocatalytic reaction is a reduction reaction.

14. The method of claim 12 wherein the photocatalytic reaction is an oxidation reaction.

15. The method of claim 12 further comprising the step of adjusting the pH of a reaction solution including the photocatalyst to pH<9.5 prior to directing light energy at the photocatalyst.

16. The method of claim 15 wherein the step of adjusting the pH comprises adjusting thre pH of the solution including the photocatalyst composition to pH<7.

17. A photocatalyst composition comprising a semiconductor material formed of a nanostructured titania material.

18. The photocatalyst composition of claim 17 wherein the nanostructured titania material is a nanostructured anatase material.

19. The photocatalyst composition of claim 17 wherein the nanostructured titania material is formed in a hydrothermal process.

20. A composite photocatalyst composition comprising:
a) a non-ferroelectric mineral material having an intrinsic electrical polarity selected from the group consisting of: tourmaline, quartz, and mixtures thereof; and
b) a photocatalyst material that is either at least partially coated on the mineral material or mixed with the mineral material to form the composite photocatalyst composition.
